(19) United States
(12) Patent Application Publication
(10) Pub. No.: US 2013/0310501 A1
(43) Pub. Date: Nov. 21, 2013

(54) TREATMENT OF PRE-HYDROPHOBATED SILICA IN SITU WITHIN A RUBBER COMPOSITION, THE RUBBER COMPOSITION AND TIRE WITH COMPONENT

(71) Applicants: Junling Zhao, Hudson, OH (US); John Joseph Andre Verthe, Kent, OH (US); Martin Paul Cohen, Fairlawn, OH (US)

(72) Inventors: Junling Zhao, Hudson, OH (US); John Joseph Andre Verthe, Kent, OH (US); Martin Paul Cohen, Fairlawn, OH (US)

(21) Appl. No.: 13/474,772

(22) Filed: May 18, 2012

(51) Int. Cl. C08K 5/548

(52) U.S. Cl. 524/262

(57) ABSTRACT

The invention relates to treatment of a pre-hydrophobated precipitated silica in situ within a rubber composition. The invention relates to preparation of treated precipitated silica by treatment of pre-hydrophobated precipitated silica in situ within a rubber composition with a bis(3-trialkoxysilylalkyl) polysulfide. The invention further comprises the resultant rubber composition and a tire having a component thereof.

This application claims the benefit of and incorporates by reference U.S. Provisional Application No. 61/502,384, filed Jun. 29, 2011.

### FIELD OF THE INVENTION

The invention relates to treatment of a pre-hydrophobated precipitated silica in situ within a rubber composition. The invention relates to preparation of treated precipitated silica by treatment of pre-hydrophobated precipitated silica in situ within a rubber composition with a bis(3-trialkoxysilylalkyl) polysulfide. The invention further comprises the resultant rubber composition and a tire having a component thereof.

### BACKGROUND OF THE INVENTION

Various diene-based elastomers may be prepared, for example, by blending the elastomer(s) with rubber reinforcing filler such as rubber reinforcing carbon black and silica reinforcement, particularly precipitated silica reinforcement, together with a coupling agent comprised of a bis(3-triethoxysilylpropyl) polysulfide or an organoalkoxymercaptosilane to aid in coupling the silica to the elastomer and enhancing its rubber reinforcing effect. Preparation of such rubber compositions are well known to those having skill in such art.

In an alternative embodiment, a pre-hydrophobated precipitated silica may be provided by pre-treating an aqueous colloidal precipitated silica (e.g. aqueous dispersion) with a combination of alkylsilane and silica coupling agent such as at least one of organoalkoxymercaptosilane and bis(3-alkoxysilylalkyl) polysulfide to form a hydrophobated precipitated silica which is recovered and dried and the dried pre-treaded precipitated silica then blended with a rubber composition instead of reacting the precipitated silica with a combination of the alkylsilane and silica coupling agent in situ within the rubber. For example, see U.S. Pat. Nos. 6,573,324, 6,649,684 and 7,704,552.

For this invention, an evaluation is undertaken to evaluate treatment of such pre-hydrophobated precipitated silica in situ within a rubber composition with a bis(3-triethoxysilylpropyl) polysulfide with the result being uncertain at the outset.

In the description of this invention, the terms “rubber”, “elastomer” and “rubbery polymer” may be used interchangeably unless otherwise indicated. The terms “cured” and “vulcanized” may be used interchangeably unless otherwise indicated.

The term “phr” refers to parts by weight of an ingredient per 100 parts by weight of rubber in a rubber composition. The term “phs” refers to parts by weight of an ingredient per 100 parts by weight of silica in a rubber composition.

Such terms are known to those having skill in such art.

### SUMMARY AND PRACTICE OF THE INVENTION

In accordance with this invention, a process is provided which comprises treating a pre-hydrophobated precipitated silica in situ within a rubber composition with a bis(3-trialkoxysilylalkyl) polysulfide;

wherein said pre-hydrophobated precipitated silica is a precipitated silica hydrophobated with a combination of an alkylsilane and at least one of an organoalkoxymercaptosilane and bis(3-alkoxysilylalkyl) polysulfide prior to its addition (of the pre-hydrophobated silica) to said rubber composition;

wherein said bis(3-trialkoxysilylalkyl) polysulfide for said pre-hydrophobation and for said in situ treatment contains an average of from about 2 to about 4, alternately an average of from about 2 to about 2.6, and alternately an average of from about 3.4 to about 3.8, connecting sulfur atoms in its polysulfidic bridge.

In one embodiment, it is envisioned that said pre-hydrophobated precipitated silica may be prepared by reacting a precipitated silica in its aqueous colloidal state with a combination of both an alkyl silane and at least one of organoalkoxymercaptosilane and bis(3-triethoxysilylpropyl) polysulfide followed by precipitation, recovery and drying of said pre-hydrophobated precipitated silica prior to its addition to said rubber composition.

Alternatively, it is envisioned that said pre-hydrophobated precipitated silica may be prepared by reacting a precipitated silica in its pre-formed state (e.g. after recovery from an aqueous colloidal state) with a combination of both an alkyl silane and at least one of organoalkoxymercaptosilane and bis(3-triethoxysilylpropyl) polysulfide prior to its addition to said rubber composition.

The invention further comprises the resultant rubber composition and a tire having a component thereof.

Accordingly, a process of preparing a rubber composition is provided wherein said process is comprised of blending:

(A) at least one diene based elastomer, and

(B) reinforcing filler which is comprised of:
(1) said pre-hydrophobated precipitated silica, or
(2) a combination of said pre-hydrophobated silica and precipitated silica (a precipitated silica which has not been pre-hydrophobated), or
(3) a combination of said pre-hydrophobated silica and rubber reinforcing carbon black, or
(4) a combination of said pre-hydrophobated silica, precipitated silica and rubber reinforcing carbon black; and
   coincidentally or subsequently blending therewith said bis(3-trialkoxysilylpropyl) polysulfide.

In further accordance with this invention, a rubber composition is provided by such process.

In further accordance with this invention, a tire is provided having at least one component (e.g. tire tread) comprised of such rubber composition.

In one embodiment, said pre-hydrophobated precipitated silica is treated in situ within the rubber composition with from about 1 to about 14, alternately from about 2 to about 10, phs (parts by weight per 100 parts by weight of the pre-hydrophobated silica) of the bis(3-trethoxysilylpropyl) polysulfide.

By being pre-hydrophobated, it is meant that the precipitated silica is hydrophobated with said combination of alkylsilane and at least one of organoalkoxymercaptosilane and bis(3-trialkoxysilylalkyl) polysulfide prior to its addition to the rubber composition.

Said bis(3-trialkoxysilylalkyl) polysulfide is preferably comprised of bis(3-triethoxysilylpropyl) polysulfide.

In practice, it is envisioned that said alkylsilane for preparation of said pre-hydrophobated precipitated silica may be comprised of the general formula (I):

Xₙ—Si—R₄₋ₙ (I)

where R is an alkyl radical having one to 18 carbon atoms, X is a radical selected from chlorine, bromine and alkoxy radicals as (R¹-0)-, where R¹ is an alkyl radical having from one to and including 3 carbon atoms, and n is an integer from 1 to 3.

Representative of said alkylsilanes are, for example, trichloro methyl silane, dichloro dimethyl silane, chloro trimethyl silane, trimethoxy methyl silane, dimethoxy dimethyl silane, methoxy trimethyl silane, trimethoxy n-propyl silane, trimethoxy isopropyl silane, trimethoxy octyl silane, trimethoxy hexadecyl silane, dimethoxy dipropyl silane, triethoxy methyl silane, triethoxy propyl silane, triethoxy octyl silane and diethoxy dimethyl silane.

Representative of said organoalkoxymercaptosilanes are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane and tripropoxy mercaptopropyl silane.

In practice the rubber of said rubber composition is comprised of at least one elastomer selected from copolymers of at least one of isoprene and 1,3-butadiene and terpolymers of styrene with at least one of isoprene and 1,3-butadiene.

Representative examples of such elastomers are, for example, c is 1,4-polyisoprene rubber (IR), (natural and synthetic), c is 1,4-polybutadiene rubber (BR), styrene-butadiene rubber (SBR), styrene-isoprene-butadiene terpolymer rubber (SIBR), styrene-isoprene rubber (SIR) and isoprene-butadiene rubber (IBR) and high vinyl polybutadiene rubber (HVPBD) having a vinyl 1,2-content in a range of from about 30 to about 80 percent.

Said process further includes sulfur curing the resulting rubber composition.

Such sulfur curing of the rubber composition is typically conducted at an elevated temperature of, for example, in a range of from about 140° C. to about 160° C.

In practice, for said in situ treatment, said bis(3-triethoxysilylpropyl) polysulfide may be added to the rubber composition commensurate with or subsequent to addition of said pre-hydrophobated precipitated silica to said rubber composition.

In practice, said preliminary blending step may be comprised of one or more blending steps.

In practice, the preliminary blending step(s) is desirably exclusive of addition of elemental sulfur.

In practice, as hereinbefore indicated, reinforcing filler added to the rubber composition may be comprised of said pre-hydrophobated precipitated silica, combination of said pre-hydrophobated precipitated silica and rubber reinforcing carbon black, combination of said pre-hydrophobated precipitated silica and precipitated silica (non pre-hydrophobated silica) and combination of said pre-hydrophobated precipitated silica, precipitated silica and rubber reinforcing carbon black.

Accordingly, said reinforcing filler in a range of, for example, about 30 to about 120 phr thereof, may be comprised of:

(A) from about 5 to about 120 phr of said pre-hydrophobated precipitated silica,

(B) from zero to about 40 phr of precipitated silica (non-pre-hydrophobated precipitated silica), and

(C) from zero to about 60 phr of rubber reinforcing carbon black.

Accordingly, said reinforcing filler may be comprised of:

(A) said pre-hydrophobated precipitated silica,

(B) combination of said pre-hydrophobated silica and precipitated silica,

(C) combination of said pre-hydrophobated silica and rubber reinforcing carbon black, and

(D) combination of said pre-hydrobated precipitated silica, precipitated silica and rubber reinforcing carbon black.

In the final blending step, (the productive mixing step) the sulfur curative comprised of elemental sulfur is understood to usually preferably also contain one or more sulfur cure accelerators, a practice well known to those having skill in such art.

In one embodiment, in the final, productive, blending step, the sulfur curative may be added to the rubber composition with or without additional silica coupling agent other than the said bis(3-ethoxysilylpropyl) polysulfide post treatment additive.

A significant aspect of the invention is the blending of only a very small amount of the post-treatment bis(3-triethoxysilylpropyl) polysulfide in situ to the pre-hydrophobated precipitated silica-containing rubber composition in a preliminary blending step (a non-productive mixing step), preferably in the absence of, or with an insignificant amount of, elemental sulfur curative to prevent, or retard, premature sulfur curing of the rubber composition in a preliminary (non-productive) blending step.

In further accordance with this invention, a rubber composition, particularly a sulfur cured rubber composition, is prepared by the process of this invention which is considered herein to be a departure from past practice.

The process of preparing said rubber composition further comprises preparing a tire assembly comprised of a rubber tire having a component of said rubber composition and sulfur curing said tire assembly.

While the mechanism, and result, of introducing said silica coupler additive with said pre-hydrophobated precipitated silica in situ within rubber in a preliminary (non-productive) mixing step may not be fully understood, it is envisioned that an integrated network would be promoted, enabled and formed at least in part between said pre-hydrophobated silica and conjugated diene-based elastomer(s) with the aid of said post-treatment.

In one embodiment, the elastomers may be tin and/or silicon coupled, preferably tin coupled, as diene-based elastomers prepared by organic solvent polymerization in the presence of a suitable tin-based catalyst complex using at least one of isoprene and 1,3-butadiene monomers or of styrene together with at least one of isoprene and 1,3-butadiene monomers. Said tin and/or silicon coupled elastomers may be selected from, for example, styrene/butadiene copolymers, isoprene/butadiene copolymers, styrene/isoprene copolymers and styrene/isoprene/butadiene terpolymers. The preparation of tin and silicon coupled elastomers via organic solvent polymerization is well known to those having skill in such art.

In one aspect, the elastomers may include one or more in-chain or end functionalized diene-based elastomers. For example, such functionalized elastomer may be provided as a diene-based elastomer as described above which contains one or more functional groups comprised of at least one of hydroxyl groups, carboxyl groups, amine groups, siloxy groups, thiol groups and epoxy groups, particularly such groups which are available to participate in reactions with, for example, precipitated silica reinforcement.

Exemplary of functionalized elastomers, where appropriate, are such as for example, functionalized styrene/butadiene copolymer elastomers (functionalized SBR elastomers) containing amine and/or siloxy (e.g. alkoxyl silane as SiOR) functional groups.

Representative of such amine functionalized SBR elastomers is, for example, SLR4601™ from Dow Chemical and T5560™ from JSR, and in-chain amine functionalized SBR elastomers mentioned in U.S. Pat. Nos. 6,735,447 and 6,936,669.

Representative of such siloxy functionalized SBR elastomers is, for example, SLR4610™ from Dow Chemical.

Representative of such combination of amine and siloxy functionalized SBR elastomers is, for example, HPR350™ from JSR.

Other and additional elastomers are functionalized styrene/butadiene copolymer elastomers (functionalized SBR elastomers) containing hydroxy or epoxy functional groups.

Representative of such hydroxy functionalized SBR elastomers is, for example, Tufdene 3330™ from Asahi.

Representative of such epoxy functionalized SBR elastomers is, for example, Tufdene E50™ from Asahi.

In practice, it is therefore envisioned that said sulfur vulcanizable elastomer may be comprised of, for example, polymers of at least one of isoprene and 1,3-butadiene; copolymers of styrene and at least one of isoprene and 1,3-butadiene; high vinyl styrene/butadiene elastomers having a vinyl 1,2-content based upon its polybutadiene in a range of from about 30 to 90 percent and functionalized copolymers comprised of styrene and 1,3-butadiene (“functionalized SBR”) selected from amine functionalized SBR, siloxy functionalized SBR, combination of amine and siloxy functionalized SBR, epoxy functionalized SBR and hydroxy functionalized SBR.

It should readily be understood by one having skill in the art that said rubber composition can be compounded by methods generally known in the rubber compounding art, such as mixing the various sulfur-vulcanizable constituent diene-based elastomers with various commonly-used additive materials such as, for example, curing aids, such as sulfur, activators, retarders and accelerators, processing additives, such as oils, resins including tackifying resins, plasticizers, fillers, pigments, zinc oxide, waxes, antioxidants and antiozonants, peptizing agents and the aforesaid reinforcing fillers as rubber reinforcing carbon black and synthetic amorphous precipitated silica aggregates. As known to those skilled in the art, depending on the intended use of the sulfur-vulcanizable and sulfur-vulcanized materials (rubbers), the various additives mentioned above are selected and commonly used in conventional amounts unless otherwise indicated herein.

The pneumatic tires are conventionally comprised of a generally toroidal-shaped carcass with an outer circumferential tread, adapted to be ground contacting, spaced beads and sidewalls extending radially from and connecting said tread to said beads.

Typical amounts of antioxidants may comprise, for example, 1 to about 5 phr. Representative antioxidants may be, for example, diphenyl-p-phenylenediamine and others, such as those disclosed in The Vanderbilt Rubber Handbook (1978), Pages 344 through 346. Suitable antiozonant(s) and waxes, particularly microcrystalline waxes, where used, may, for example, be of the type shown in The Vanderbilt Rubber Handbook (1978), Pages 346 and 347. Typical amounts of antiozonants where used, may, for example, comprise 1 to about 5 phr. Typical amounts of zinc oxide may, for example, comprise from 2 to about 5 phr. Typical amounts of waxes, where used, may comprise, for example, from 1 to about 5 phr. Typical amounts of peptizers, where used, may, for example, comprise from 0.1 to about 1 phr. The presence and relative amounts of the above additives are not normally considered herein as a significant aspect of the present invention.

The vulcanization of the elastomer composition is conducted in the presence of a sulfur-vulcanizing agent. Examples of suitable sulfur-vulcanizing agents include elemental sulfur (free sulfur) or sulfur-donating vulcanizing agents, for example, an amine disulfide, polymeric polysulfide or sulfur olefin adducts. Preferably, the sulfur-vulcanizing agent is elemental sulfur. Such sulfur-vulcanizing agents may normally used are used, for example, in an amount ranging from about 0.5 to about 5 phr with a range of from 1.5 to 2.3 being often preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from, for example, about 0.5 to about 2 phr. In another embodiment, combinations of two or more accelerators might be used, if desired and where appropriate, in which a primary accelerator is might be used in the larger amount of, for example, from 0.5 to 1.0 phr, and a secondary accelerator which might be used in smaller amounts, for example, from 0.05 to 50 phr, in order to activate the sulfur vulcanization process. Combinations of such accelerators have historically been sometimes known to produce a synergistic effect of the final properties of sulfur-cured rubbers and are sometimes somewhat better than those produced by use of either accelerator alone. In addition, delayed action accelerators may be used, where appropriate which are less affected by normal processing temperatures but might produce satisfactory cures at ordinary vulcanization temperatures. Representative examples of accelerators include, for example, various amines, disulfides, diphenyl guanidine, thioureas, thiazoles, thiurams, sulfenamides, dithiocarbamates and xanthates, particularly diphenyl guanidine. The primary accelerator might be, for example, a sulfenamide such as, for example, N-cyclohexyl-2-sulfenamide. If a second accelerator is used, the secondary accelerator might be selected from, for example, the diphenyl guanidine, a dithiocarbamate or a thiuram compound.

The tire can be built, shaped, molded and cured by various methods which will be readily apparent to those having skill in the art.

Such unvulcanized tread rubber composition (e.g. in a form of an extruded rubber strip) can be applied in the building of the green (unvulcanized) rubber tire in which the uncured, shaped tread is built onto the carcass following which the green tire is shaped and cured.

Alternately, an unvulcanized, or partially vulcanized, tread rubber strip can be applied to a cured tire carcass from which the previous tread has been buffed or abraded away and the tread cured thereon as a retread.

The practice of this invention is further illustrated by reference to the following examples which are intended to be representative rather than restrictive of the scope of the invention. Unless otherwise indicated, all parts and percentages are by weight.

### EXAMPLE I

A base rubber formulation is provided as illustrated in Table 1 for a rubber composition containing reinforcing filler as rubber reinforcing carbon black without an inclusion of pre-hydrophobated precipitated silica. Evaluation of an addition of a silica coupler comprised of a bis(3-triethoxysilylpropyl) polysulfide to the rubber composition is proposed for this Example.

The parts and percentages are by weight unless otherwise indicated.

TABLE 1

| | Parts (phr) |
|---|---|
| First Non-Productive Mixing Step (NP) - Mixed to 160° C. | |
| Natural cis 1,4-polyisoprene rubber¹ | 87.5 |
| Styrene/butadiene rubber (SBR)² | 7.5 |
| Cis 1,4-polybutadiene rubber³ | 5 |
| Carbon black, rubber reinforcing⁴ | 49 |
| Bis(3-triethoxysilylpropyl) tetrasulfide composite⁵ | 0 and 4 |
| Bis(3-triethoxysilylpropyl) disulfide composite⁶ | 0 and 4 |
| Wax, microcrystalline and paraffin | 1.5 |
| Fatty acid⁷ | 2 |
| Antioxidants | 3.5 |
| Zinc oxide | 3 |
| Productive Mixing Step (PR) - Mixed to 110° C. | |
| Sulfur | 1 |
| Sulfur vulcanization accelerator(s)⁸ | 1.5 |

¹Natural cis 1,4-polyisoprene rubber
²Styrene/butadiene rubber (SBR) as PLF1502 ™ from The Goodyear Tire & Rubber Company
³High cis 1,4-polybutadiene rubber as BUD1207 ™ from The Goodyear Tire & Rubber Company
⁴Rubber reinforcing carbon black as N205, an ASTM designation
⁵Composite of a 50/50 weight ratio of carbon black and bis(3-triethoxysilylpropyl) polysulfide (tetrasulfide) having an average of from about 3.4 to about 3.8 connecting sulfur atoms in its polysulfidic bridge as Si69 ™ from Degussa-Evonik
⁶Composite of a 50/50 weight ratio of carbon black and bis(3-triethoxysilylpropyl) polysulfide (disulfide) having an average of from about 2 to about 2.6 connecting sulfur atoms in its polysulfidic bridge as Si266 ™ from Degussa-Evonik
⁷Fatty acid comprised of stearic acid, palmitic acid and oleic acid.
⁸Sulfenamide and diphenyl guanidine sulfur vulcanization accelerators

### EXAMPLE II

Conjugated diene-based elastomer compositions were prepared based on the carbon black-containing reinforcement formulation in Table 1 of Example I and identified as Rubber Compositions A through C. Rubber Composition A is a Control rubber composition in the sense that a bis(3-triethoxysilylpropyl) polysulfide silica coupling agent is not added to the rubber reinforcing carbon black-containing rubber composition.

Experimental Rubber Composition B is an experimental rubber evaluation in the sense that a small amount of silica coupling agent as bis(3-triethoxysilylpropyl) polysulfide (disulfide) having an average in a range of from about 2 to about 2.6 connecting sulfur atoms in its polysulfidic bridge commensurate with addition of the rubber reinforcing carbon black to the rubber composition.

Experimental Rubber Composition C is an experimental rubber evaluation in the sense that a small amount of a silica coupling agent as a bis(3-triethoxysilylpropyl) polysulfide (tetrasulfide) having an average in a range of from about 3.4 to about 3.8 connecting sulfur atoms in its polysulfidic bridge commensurate with addition of the rubber reinforcing carbon black to the rubber composition.

Various physical properties are presented in Table 2 and reported in parts and percentages by weight (e.g. parts by weight per 100 parts by weight rubber, or phr) unless otherwise indicated.

TABLE 2

| | Rubber Composiitions (phr) | | |
|---|---|---|---|
| | A | B | C |
| Ingredients | | | |
| Carbon black, rubber reinforcing | 49 | 49 | 49 |
| Bis(3-triethoxysilylpropyl) | 0 | 0 | 4 |
| tetrasulfide composite | | | |
| Bis(3-triethoxysilylpropyl) | 0 | 4 | 0 |
| disulfide composite | | | |
| Physical Properties | | | |
| RPA (Rubber Process Analyzer) | | | |
| test (15% dynamic strain, | | | |
| 0.83 Hertz, 100° C.) | | | |
| Uncured dynamic storage | 169 | 163 | 157 |
| modulus G′ (KPa) | | | |
| RPA¹, 100° C., 10% strain, | | | |
| (cured at 150° C. for 30 minutes) | | | |
| Dynamic storage modulus G′ (MPa) | 0.977 | 0.955 | 1.05 |
| Tan delta | 0.202 | 0.205 | 0.173 |
| ATS² (cured at 150° C. | | | |
| for 32 minutes) | | | |
| Tensile strength (MPa) | 25.4 | 24.8 | 26.3 |
| Elongation at break (%) | 527 | 569 | 529 |
| 100% modulus, ring, (MPa) | 2.26 | 2.06 | 2.55 |
| 300% modulus, ring, (MPa) | 12.9 | 11.1 | 13.8 |
| Rebound | | | |
| 23° C. | 42 | 41 | 45 |
| 100° C. | 57 | 53 | 59 |
| Shore A Hardness | | | |
| 23° C. | 65 | 65 | 65 |
| 100° C. | 57 | 57 | 58 |
| Tear Strength³, N | | | |
| At 95° C., Original | 199 | 230 | 164 |
| At 95° C., Aged 7 days at 70° C. | 142 | 155 | 142 |
| Abrasion rate (mg/km), Grosch⁴ | | | |
| Medium severity (40N), 6° slip | 53 | 64 | 63 |
| angle, disk Speed = 20 km/hr, | | | |
| distance = 1,000 meters | | | |
| High severity (70N), 12° slip | 745 | 912 | 794 |
| angle, disk speed = 20 km/hr, | | | |
| distance = 250 meters | | | |
| Ultra High severity (70N), 16° slip | 2625 | 3090 | 2507 |
| angle, disk Speed = 20 km/hr, | | | |
| distance = 500 meters | | | |

¹RPA: Rubber Process Analyzer
²ATS: tensile/elongation test system apparatus
³Data obtained according to a tear strength (peal adhesion) test to determine interfacial adhesion between two samples of a rubber composition. In particular, such interfacial adhesion is determined by pulling one rubber composition away from the other at a right angle to the untorn test specimen with the two ends of the rubber compositions being pulled apart at a 180° angle to each other using an Instron instrument at 95° C. and reported as Newtons force.
⁴The Grosch abrasion rate run on an LAT-100 Abrader and is measured in terms of mg/km of rubber abraded away. The test rubber sample is placed at a slip angle under constant load (Newtons) as it traverses a given distance on a rotating abrasive disk (disk from HB Schleifmittel GmbH). In practice, a low abrasion severity test may be run, for example, at a load of 20 Newtons, 2° slip angle, disk speed of 40 km/hr for a distance of 7,500 meters; a medium abrasion severity test may be run, for example, at a load of 40 Newtons, 6° slip angle, disk speed of 20 km/hr and distance of 1,000 meters; a high abrasion severity test may be run, for example, at a load of 70 Newtons, 12° slip angle, disk speed of 20 km/hr and distance of 250 meters; and an ultra high abrasion severity test may be run, for example, at a load of 70 Newtons, 16° slip angle, disk speed of 20 km/hr and distance of 500 meters.

It can be seen from Table 2 that addition of the individual bis(3-triethoxysilylpropyl) polysulfide coupling agents (the tetrasulfide and the disulfide based coupling agents) had little, if any, effect on the reported physical properties of the rubber composition in which its reinforcing filler was a rubber reinforcing carbon black for Rubber Compositions B and C as compared to Rubber Composition A without addition of any of the coupling agents.

### EXAMPLE III

A base rubber formulation is provided as illustrated in Table 3 for a rubber composition utilizing an inclusion of a pre-hydrophobated silica envisioned as being pre-hydrophobated by a combination of alkylsilane and at least one of bis(3-triethoxysilylpropyl) polysulfide and organoalkoxymercaptosilane. Evaluation of an addition of a silica coupler (silica coupling agent) comprised of a bis(3-triethoxysilylpropyl) polysulfide to the rubber composition is proposed with the result being uncertain in view of the aforesaid results for the carbon black reinforcing filler-containing rubber composition reported in Example II.

The parts and percentages are by weight unless otherwise indicated.

TABLE 3

| | Parts (phr) (or phs |
|---|---|
| | for the polysulfide) |
| First Non-Productive Mixing Step | |
| (NP) - Mixed to 160° C. | |
| Natural cis 1,4-polyisoprene rubber¹ | 100 |
| Carbon black, rubber reinforcing² | 5 |
| Pre-hydrophobated precipitated silica³ | 50 |
| Bis(3-triethoxysilylpropyl) tetrasulfide composite⁴ | 0, 4, 8* |
| Bis(3-triethoxysilylpropyl) disulfide composite⁵ | 0, 4, 8* |
| Wax, microcrystalline and paraffin | 1.5 |
| Fatty acid⁶ | 2 |
| Antioxidants | 3.5 |
| Zinc oxide | 3 |
| Productive Mixing Step (PR) - Mixed to 110° C. | |
| Sulfur | 1.2 |
| Sulfur vulcanization accelerator(s)⁷ | 1.1 |

*0, 2 and 4 phr
¹Natural cis 1,4-polyisoprene rubber
²Rubber reinforcing carbon black as N205, an ASTM designation
³Pre-hydrophobated precipitated silica envisioned as precipitated silica treated with a combination of alkylsilane and at least one of organoalkoxymercaptosilane and bis(3-triethoxysilylpropyl) polysulfide containing an average of from about 2 to about 4 sulfur atoms in its polysulfidic bridge
⁴Composite of a 50/50 weight ratio of carbon black and bis(3-triethoxysilylpropyl) polysulfide (tetrasulfide) having an average of from about 3.4 to about 3.8 connecting sulfur atoms in its polysulfidic bridge as Si69 ™ from Degussa-Evonic
⁵Composite of a 50/50 weight ratio of carbon black and bis(3-triethoxysilylpropyl) polysulfide (disulfide) having an average of from about 2 to about 2.6 connecting sulfur atoms in its polysulfidic bridge as Si266 ™ from Degussa-Evonic
⁶Fatty acid comprised of stearic acid, palmitic acid and oleic acid.
⁷Sulfenamide and diphenyl guanidine sulfur vulcanization accelerators

### EXAMPLE IV

Conjugated diene-based elastomer compositions were prepared based on the formulation in Table 3 of Example III and identified as Rubber Compositions D, E and F.

To Control Rubber Composition D, 50 phr of the pre-hydrophobated silica is added without any addition of a small amount of bis(3-triethoxysilylpropyl) polysulfide silica coupling agent to the rubber composition.

To Experimental evaluation Rubber Compositions E and F is added both 50 phr of the pre-hydrophobated silica and a small amount (2 and 4 phr, or 4 and 8 phs, respectively) of silica coupling agent as the bis(3-triethoxysilylpropyl) disulfide.

Various physical properties are presented in Table 4 and reported in parts and percentages by weight (e.g. parts by weight per 100 parts by weight rubber, or phr) unless otherwise indicated.

TABLE 4

| | Rubber Composiitions | | |
|---|---|---|---|
| | D | E | F |
| Ingredients | | | |
| Pre-hydrophobated silica (phr) | 50 | 50 | 50 |
| Bis(3-triethoxysilylpropyl) | 0 | 4 | 8 |
| disulfide composite (phs) | | | (0, 2 and 4 |
| | | | phr) |
| Physical Properties | | | |
| RPA (Rubber Process Analyzer) test | | | |
| (15% dynamic strain, | | | |
| 0.83 Hertz, 100° C.) | | | |
| Uncured dynamic storage | 216 | 144 | 137 |
| modulus G′ (KPa) | | | |
| RPA¹, 100° C., 10% strain, | | | |
| (cured at 150° C. for 30 minutes) | | | |
| Dynamic storage | 0.683 | 0.757 | 0.836 |
| modulus G′ (MPa) | | | |
| Tan delta | 0.106 | 0.09 | 0.084 |
| ATS² (cured at 150° C. | | | |
| for 32 minutes) | | | |
| Tensile strength (MPa) | 24.2 | 25.2 | 26.3 |
| Elongation at break (%) | 585 | 528 | 518 |
| 100% modulus, ring, (MPa) | 1.47 | 2.08 | 2.39 |
| 300% modulus, ring, (MPa) | 8.93 | 12.6 | 14.1 |
| Rebound | | | |
| 23° C. | 58 | 59 | 59 |
| 100° C. | 73 | 75 | 75 |
| Shore A Hardness | | | |
| 23° C. | 53 | 57 | 60 |
| 100° C. | 49 | 54 | 56 |
| Tear Strength³, N | | | |
| At 23° C. | 226 | 196 | 173 |
| At 95° C., Original | 172 | 107 | 85 |
| At 95° C., Aged 7 days at 70° C. | 184 | 155 | 117 |
| Abrasion rate (mg/km), Grosch4 | | | |
| Medium severity (40N), 6° slip | 101 | 98 | 89 |
| angle, disk Speed = 20 km/hr, | | | |
| distance = 1,000 meters | | | |
| High severity (70N), 12° slip | 1406 | 1247 | 1140 |
| angle, disk speed = 20 km/hr, | | | |
| distance = 250 meters | | | |
| Ultra High severity (70N), 16° slip | 4331 | 3828 | 3122 |
| angle, disk Speed = 20 km/hr, | | | |
| distance = 500 meters | | | |

It can be seen from Table 4 that the addition of the silica coupling agent as bis(3-triethoxysilylpropyl) disulfide composite in amounts of 4 and 8 phs to the rubber composition along with the pre-hydrophobated silica was discovered to result in a progressive decrease in the uncured storage modulus G′ value for Experimental Rubber Compositions E and F of 144 and 137 KPa, respectively as compared to Control Rubber Composition D of 216 KPa which is surprisingly indicative of a softening of the uncured rubber composition to yield better, improved, rubber processing conditions.

This is considered to be a significant discovery which is beneficially indicative of better processability such as for example extrusion of the mixed rubber composition, such as for use in forming an uncured tire tread rubber strip.

Also, that the tan delta values (cured at 10 percent strain) for Experimental Rubber Compositions E and F progressively decreased from 0.09 to 0.084 as compared to the tan delta value of 0.106 for Control Rubber Composition D which is beneficially indicative of reduced hysteresis for the rubber composition which may be related to reduced internal heat build-up and improved (reduced) rolling resistance for a tire with a tread of such rubber composition.

It can further be seen from Table 4 that tensile strength and modulus values for Experimental Rubber Compositions E and F also progressively increased as compared to Control Rubber Composition D. Also, the abrasion rate of Experimental Rubber Samples E and F was surprisingly progressively and beneficially reduced as compared to Control Rubber Sample D. These results were also considered to be a significant which is beneficially indicative of improved performance when the rubber composition is used as a tire tread.

Therefore, it is concluded that the addition of the small amount of the bis(3-triethoxysilylpropyl) disulfide silica coupling agent to a rubber composition including the pre-hydrophobated precipitated silica envisioned as being hydrophobated by a combination of an alkyl silane and at least one of bis(3-triethoxysilylpropane) polysulfide or organoalkoxymercaptosilane resulted in significant improvements in both processing of the uncured rubber composition and performance values for the sulfur cured rubber composition.

### EXAMPLE V

Conjugated diene-based elastomer compositions were prepared based on the formulation in Table 3 of Example III and identified as Rubber Compositions G, H and I.

To Control Rubber Composition G, 50 phr of the pre-hydrophobated silica is added without any addition of a small amount of (bis(3-triethoxysilylpropyl) polysulfide silica coupling agent to the rubber composition.

To Experimental evaluation Rubber Compositions H and I is added both 50 phr of the pre-hydrophobated silica and a small amount (2 and 4 phr, or 4 and 8 phs, respectively) of silica coupler as the bis(3-triethoxysilylpropyl) tetrasulfide.

Various physical properties are presented in Table 5 and reported in parts and percentages by weight (e.g. parts by weight per 100 parts by weight rubber, or phr) unless otherwise indicated.

TABLE 5

| | Rubber Compositions | | |
|---|---|---|---|
| | G | H | I |
| Ingredients | | | |
| Pre-hydrophobated silica (phr) | 50 | 50 | 50 |
| Bis(3-triethoxysilylpropyl) | 0 | 4 | 8 |
| tetrasulfide composite (phs) | | | (0, 2 and |
| | | | 4 phr) |
| Physical Properties | | | |
| RPA (Rubber Process Analyzer) test | | | |
| (15% dynamic strain, 0.83 Hertz, | | | |
| 100° C.) | | | |
| Uncured dynamic storage | 216 | 178 | 162 |
| modulus G′ (KPa) | | | |
| RPA¹, 100° C., 10% strain, | | | |
| (cured at 150° C. for 30 minutes) | | | |
| Dynamic storage modulus G′ (MPa) | 0.683 | 0.855 | 0.988 |
| Tan delta | 0.106 | 0.084 | 0.07 |
| ATS¹ (cured at 150° C. | | | |
| for 32 minutes) | | | |
| Tensile strength (MPa) | 24.2 | 26.3 | 27.2 |
| Elongation at break (%) | 585 | 516 | 474 |
| 100% modulus, ring, (MPa) | 1.47 | 2.37 | 2.99 |
| 300% modulus, ring, (MPa) | 8.93 | 14.2 | 17.1 |
| Rebound | | | |
| 23° C. | 58 | 60 | 61 |
| 100° C. | 73 | 77 | 77 |
| Shore A Hardness | | | |
| 23° C. | 53 | 59 | 64 |
| 100° C. | 49 | 56 | 59 |
| Tear Strength¹, N | | | |
| At 23° C. | 226 | 195 | 116 |
| At 95° C., Original | 172 | 105 | 60 |
| At 95° C., Aged 7 days at 70° C. | 184 | 120 | 74 |
| Abrasion rate (mg/km), Grosch2 | | | |
| Medium severity (40N), 6° slip | 101 | 88 | 77 |
| angle, disk Speed = 20 km/hr, | | | |
| distance = 1,000 meters | | | |
| High severity (70N), 12° slip | 1406 | 1149 | 917 |
| angle, disk speed = 20 km/hr, | | | |
| distance = 250 meters | | | |
| Ultra High severity (70N), 16° slip | 4331 | 3343 | 2360 |
| angle, disk Speed = 20 km/hr, | | | |
| distance = 500 meters | | | |

It can be seen from Table 5 that the addition of the silica coupling agent as bis(3-triethoxysilylpropyl) tetrasulfide composite in amounts of 4 and 8 phs to the rubber composition along with the pre-hydrophobated silica surprisingly resulted in a decrease in the uncured storage modulus G′ value for Experimental Rubber Compositions H and I of 178 and 162 KPa, respectively as compared to Control Rubber Composition G of 216 KPa which is indicative of a softening of the uncured rubber composition to result in better, improved, rubber processing conditions.

This is considered herein to be a significant discovery in a sense of better processability of the rubber composition such as for example extrusion of the mixed rubber composition, such as for use in forming an uncured tire rubber tread strip.

Also, that the tan delta values (cured at 10 percent strain) for Experimental Rubber Compositions H and I progressively decreased from 0.084 to 0.07 as compared to the tan delta value of 0.106 for Control Rubber Composition G which is surprisingly beneficially indicative of reduced hysteresis of the rubber composition which may be related to reduced internal heat build-up during working of the cured rubber composition and improved (reduced) rolling resistance for a tire with tread of such rubber composition.

It can further be seen from Table 5 that tensile strength and modulus values for Experimental Rubber Compositions H and I also progressively increased as compared to Control Rubber Composition G. Also, the abrasion rate of Experimental Rubber Samples H and I was progressively and significantly beneficially reduced as compared to Control Rubber Sample G. These results were also considered to be a significant which is beneficially indicative of improved performance when the rubber composition is used as a tire tread.

Therefore, it is concluded that the addition of the small amount of the bis(3-triethoxysilylpropyl) tetrasulfide silica coupling agent to a rubber composition including the pre-hydrophobated precipitated silica envisioned as being hydrophobated by a combination of an alkyl silane and at least one of bis(3-triethoxysilylpropane) polysulfide or organoalkoxymercaptosilane resulted in significant improvements in both processing of the uncured rubber composition and performance values for the sulfur cured rubber composition.

For the Examples, the rubber compositions are prepared by mixing the ingredients, other than the sulfur and said accelerators in a preliminary first “non-productive” mixing step in an in internal rubber mixer followed by mixing in a final “productive” mixing step, also in an internal rubber mixer, in which the sulfur and sulfur cure accelerator are added.

The mixed ingredients were dumped from each of the respective internal rubber mixers, sheeted from an open mill roll and allowed to cool at least down to 40° C., or lower, prior to the next mixing step.

While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A process which comprises treating a pre-hydrophobated precipitated silica in situ within a rubber composition with a bis(3-trialkoxysilylalkyl) polylsulfide;
wherein said pre-hydrophobated precipitated silica is a precipitated silica hydrophobated with a combination of an alkylsilane and at least one of an organoalkoxymercaptosilane and bis(3-alkoxysilylalkyl) polysulfide prior to its addition (of the pre-hydrophobated silica) to said rubber composition;
wherein said bis(3-trialkoxysilylalkyl) polysulfide for said pre-hydrophobation and for said in situ treatment contains an average of from about 2 to about 4 connecting sulfur atoms in its polysulfidic bridge; and
wherein said pre-hydrophobated silica is treated in situ within the rubber composition with from about 1 to about 14 parts by weight of said bis(3-trialkoxysilyl propyl) polysulfide per 100 parts by weight of said pre-hydrophobated precipitated silica.

2. The process of claim 1 wherein said bis(3-trialkoxysilylalkyl) polysulfide is comprised of a bis(3-triethoxysilylpropyl) polysulfide.

3. The process of claim 1 wherein said bis(3-triethoxysilylpropyl) polysulfide contains an average of from about 2 to about 2.6 connecting sulfur atoms in its polysulfidic bridge.

4. The process of claim 1 wherein said bis(3-triethoxysilylpropyl) polysulfide contains an average of from about 3.4 to about 3.8 connecting sulfur atoms in its polysulfidic bridge.

5. The process of claim 1 wherein said pre-hydrophobated precipitated silica is prepared by reacting a precipitated silica in its aqueous colloidal state with a combination of both of said alkyl silane and at least one of organoalkoxymercaptosilane and bis(3-triethoxysilylpropyl) polysulfide followed by precipitation, recovery and drying of said pre-hydrophobated precipitated silica prior to its addition to said rubber composition.

6. The process of claim 1 wherein said pre-hydrophobated precipitated silica is prepared by treating precipitated silica in its pre-formed state with a combination of both said alkyl silane and at least one of organoalkoxymercaptosilane and bis(3-triethoxysilylpropyl) polysulfide prior to its addition to said rubber composition.

7. The process of claim 1 wherein said pre-hydrophobated precipitated silica is a precipitated silica treated with a combination of alkyl silane and organoalkoxymercaptosilane.

8. The process of claim 1 wherein said pre-hydrophobated precipitated silica is a precipitated silica treated with a combination of alkyl silane and bis(3-trialkoxysilylalkyl) polysulfide having an average of from about 2 to about 4 connecting sulfur atoms in its polysulfidic bridge.

9. The process of claim 8 wherein said bis(3-trialkoxysilylalkyl) polysulfide is comprised of a bis(3-triethoxysilylpropyl) polysulfide.

10. The process of claim 1 wherein said alkyl silane is comprised of at least one of trichloro methyl silane, dichloro dimethyl silane, chloro trimethyl silane, trimethoxy methyl silane, dimethoxy dimethyl silane, methoxy trimethyl silane, trimethoxy n-propyl silane, trimethoxy isopropyl silane, trimethoxy octyl silane, trimethoxy hexadecyl silane, dimethoxy dipropyl silane, triethoxy methyl silane, triethoxy propyl silane, triethoxy octyl silane and diethoxy dimethyl silane.

11. The process of claim 1 wherein said organoalkoxymercaptosilane is comprised of at least one of triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane and tripropoxy mercaptopropyl silane.

12. A rubber composition containing said treated pre-hydrophobated precipitated silica prepared according to the process of claim 1.

13. The process of claim 1 which comprises blending:
(A) at least one diene based elastomer, and
(B) reinforcing filler comprised of:
(1) said pre-hydrophobated precipitated silica, or
(2) a combination of said pre-hydrophobated silica and precipitated silica (a precipitated silica which has not been pre-hydrophobated), or
(3) a combination of said pre-hydrophobated silica and rubber reinforcing carbon black, or
(4) a combination of said pre-hydrophobated silica, precipitate silica and rubber reinforcing carbon black;
coincidentally or subsequently blending therewith said bis(3-trialkoxysilylpropyl) polysulfide.

14. The process of claim 13 wherein said reinforcing filler is provided in an amount ranging from about 30 to about 120 phr comprised of:
(A) from about 5 to about 120 phr of said pre-hydrophobated precipitated silica,
(B) from zero to about 40 phr of precipitated silica (non-prehydrophobated precipitated silica), and
(C) from zero to about 60 phr of rubber reinforcing carbon black.

15. The process of claim 13 wherein said diene-based elastomer is comprised of at least one elastomer selected from copolymers of at least one of isoprene and 1,3-butadiene and terpolymers of styrene with at least one of isoprene and 1,3-butadiene;
wherein, optionally, at least one of said elastomers may be:
(A) a tin and/or silicon coupled elastomer, or
(B) an in-chain or end functionalized elastomer wherein functional groups for said functionalized elastomer are comprised of at least one of hydroxyl groups, carboxyl groups, amine groups, siloxy groups, thiol groups and epoxy groups.

16. A rubber composition prepared by the process of claim 13.

17. A rubber composition prepared by the process of claim 13.

18. A tire having a component comprised of the rubber composition of claim 12.

19. A tire having a component comprised of the rubber composition of claim 14.

20. A tire having a component comprised of the rubber composition of claim 16.
